(19) United States
(12) Patent Application Publication
(10) Pub. No.: US 2026/0109333 A1
(43) Pub. Date: Apr. 23, 2026

(54) BRAKE ACTUATOR COVER

(71) Applicant: White River Marine Group, LLC, Springfield, MO (US)

(72) Inventor: Rick Huddleston, Yellville, AR (US)

(73) Assignee: White River Marine Group, LLC, Springfield, MO (US)

(21) Appl. No.: 19/359,166

(22) Filed: Oct. 15, 2025

Related U.S. Application Data
(60) Provisional application No. 63/709,923, filed on Oct. 21, 2024.

(51) Int. Cl. B60T 17/00; B60T 13/74; B62D 65/12; B60P 3/10

(52) U.S. Cl. CPC B60T 17/00; B60T 13/745; B62D 65/12; B60P 3/1033

(57) ABSTRACT

An electric over hydraulic brake system for a watercraft trailer, a watercraft trailer having such a system, and methods for using such a system and equipping a watercraft trailer with such a system are disclosed. The electric over hydraulic brake system includes a platform, an electric over hydraulic brake actuator that is mountable to and/or mounted to the platform, and a cover that is mountable to and/or mounted to the platform, such that the cover at least partially encloses an interior cavity inside of which the electric over hydraulic brake actuator is disposed when the cover is mounted to the platform with the electric over hydraulic brake actuator. Submerging the electric over hydraulic brake system within a fluid, such as a body of water, traps a pocket of air within the cover that protects the electric over hydraulic brake actuator disposed therein.

### CROSS-REFERENCE TO RELATED APPLICATIONS

This application claims benefit to U.S. Provisional Application Serial No. 63/709,923 filed October 21, 2024, the entirety of which is incorporated by reference herein.

### TECHNICAL FIELD

The present disclosure relates generally to watercraft trailers, and more specifically environmental covers for hardware, actuators, and/or the like provided on said watercraft trailers.

### BACKGROUND

Watercraft trailers present unique braking challenges due to their frequent exposure to corrosive marine environments and the need for submersible operation at boat ramps. Traditional surge brake systems operate by allowing the forward momentum of the trailer to compress a master cylinder located at and/or near the coupling between the trailer and the towing vehicle, which in turn applies a braking force at the wheels of the trailer through various means. However, surge brake systems suffer from various challenges, including the inability to provide proportional braking control, the tendency to engage inadvertently when reversing, and a susceptibility to water contamination during launch and retrieval operations. Furthermore, surge brakes often cannot be adjusted independently by the tow vehicle operator and do not typically provide means for manual override or adjustment to account for various road and/or loading conditions.

Electric hydraulic brake systems have emerged as an alternative for watercraft trailer applications by combining the reliable stopping power of hydraulic actuation with the precise control afforded by electric activation from the tow vehicle’s brake controller. These systems typically utilize an electric pump motor assembly that pressurizes hydraulic fluid to actuate brake calipers, drums, and/or the like in response to signals from the tow vehicle, enabling a controlled, proportional braking force that can be adjusted based on deceleration rate, trailer load, operator preference, and more. Unlike electric-only braking systems that rely on magnets or the like, electric hydraulic systems maintain consistent braking performance when components are wet and provide superior heat dissipation through hydraulic fluid circulation, making them particularly well-suited for the demanding conditions encountered in marine trailering applications where heavy loads must be controlled during steep launch ramp descents.

### SUMMARY

In one embodiment, an electric over hydraulic brake system includes a platform, an electric over hydraulic brake actuator, and a cover. The platform is configured to mount to a watercraft trailer. The electric over hydraulic brake actuator is mountable to the platform and is configured to actuate one or more brakes of the watercraft trailer. The cover is configured to mount to the platform, such that the cover at least partially encloses an interior cavity inside of which the electric over hydraulic brake actuator is disposed when the cover is mounted to the platform with the electric over hydraulic brake actuator.

In another embodiment, a watercraft trailer having an electric over hydraulic brake system. The electric over hydraulic brake system includes a platform, an electric over hydraulic brake actuator, and a cover. The platform is configured to mount to a watercraft trailer. The electric over hydraulic brake actuator is mountable to the platform and is configured to actuate one or more brakes of the watercraft trailer. The cover is configured to mount to the platform, such that the cover at least partially encloses an interior cavity inside of which the electric over hydraulic brake actuator is disposed when the cover is mounted to the platform with the electric over hydraulic brake actuator.

In another embodiment, a method for using a watercraft trailer having an electric over hydraulic brake system. The electric over hydraulic brake system includes a platform, an electric over hydraulic brake actuator, and a cover. The platform is configured to mount to a watercraft trailer. The electric over hydraulic brake actuator is mountable to the platform and is configured to actuate one or more brakes of the watercraft trailer. The cover is configured to mount to the platform, such that the cover at least partially encloses an interior cavity inside of which the electric over hydraulic brake actuator is disposed when the cover is mounted to the platform with the electric over hydraulic brake actuator. The method includes the steps of mounting the electric over hydraulic brake system to the watercraft trailer and conveying the watercraft trailer at least partially into a body of water so as to at least partially submerge the electric over hydraulic brake system in the body of water.

In another embodiment, a method for equipping a watercraft trailer with an electric over hydraulic brake system. The method includes a step of providing a watercraft trailer, a step of mounting an electric over hydraulic brake actuator to the platform, and a step for mounting a cover to the platform. When mounted in this way, the cover at least partially encloses an interior cavity inside of which the electric over hydraulic brake actuator is disposed.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative watercraft trailer having an electric over hydraulic braking system as described and illustrated herein;

FIG. 2 schematically depicts an illustrative cover for an electric over hydraulic braking system as described and illustrated herein;

FIG. 3 schematically depicts an illustrative electric over hydraulic braking system with a cover removed as described and illustrated herein;

FIG. 4 schematically depicts a cross section of an illustrative electric over hydraulic braking system and cover as described and illustrated herein;

FIG. 5 schematically depicts an illustrative cover for an electric over hydraulic braking system as described and illustrated herein, seen from below;

FIG. 6A schematically depicts an illustrative scenario in which an electric over hydraulic system with cover as described an illustrated herein is submerged in water;

FIG. 6B schematically depicts an illustrative scenario in which an electric over hydraulic system with cover as described an illustrated herein is submerged in water at an angle; and

FIG. 7 shows an illustrative method for equipping a watercraft trailer with an electric over hydraulic system.

### DETAILED DESCRIPTION

One challenge with electric over hydraulic brake actuators is that submersion of the actuator can adversely affect the operation of the actuator or damage the actuator. Typically, the housing of the actuator is designed to withstand rain or other incidental moisture, such as that encountered when driving down the road. However, electric over hydraulic brake actuators are not typically designed to withstand complete submersion in water. This limitation can be especially problematic when attempting to use electric over hydraulic brake actuators with watercraft trailers, given that many of these trailers are intended to be submerged in water. When launching or retrieving a watercraft, a truck or tow vehicle typically backs the trailer down a watercraft ramp or launch ramp, into the water, until such a point that the watercraft provided thereon floats off the trailer. Depending on the size of the watercraft, this can require submerging a substantial portion of the trailer.

While such trailers may still be equipped with electric over hydraulic brake actuators despite these issues, doing so requires locating the actuator at the front of the trailer, as this is the only position along the trailer that may avoid submersion in the water when launching a watercraft. However, locating the actuator at the front of the trailer extends the length of those brake lines needed to connect the actuator to the brake pistons. Longer brake lines may require larger actuator units, may result in “spongier” brakes, may result in slower response times, and may result in less brake power due to pressure losses along the lines. Longer brake lines also pose additional routing challenges and require additional fasteners, clips, or the like to keep the line reliably secured to the trailer – all of which become additional potential failure points.

Additionally, the front of the trailer tends to be an exceptionally visible spot, and electric over hydraulic brake actuators are not typically designed to be very aesthetic. For some discerning customers, the actuator units may be considered an eyesore, which can impact adoption or a customer’s willingness to add an electric over hydraulic brake actuator to their trailer package.

Accordingly, a need exists for an electric over hydraulic brake actuator and/or system that can be located at other positions along a watercraft trailer despite the submersion risks.

Those embodiments disclosed and illustrated herein provide for a platform and cover for supporting and protecting an electric over hydraulic brake actuator and/or system so that the actuator may be placed closer to the axles which are braked by the system and/or may be placed at locations that are less visible, all while protecting the actuator from submersion when launching or retrieving a watercraft. The cover sits overtop the actuator so that, when submerged in water or some other fluid, the cover traps an air pocket that prevents at least some ingress of water, thereby protecting the actuator.

As used herein, “top,” “bottom”, “up,” and “down” refer to directions relative to gravity and a corresponding height direction of the watercraft trailer.

As used herein, the term “watercraft” may refer to any fishing boat (e.g., bass boats, aluminum boats, flats/skiffs), recreational power boats (e.g., bowriders, deck boats, ski/wakeboard boats, pontoon boats), personal watercraft (e.g., jet skis, stand-ups), sailing vessels (e.g., keelboats, daysailers, catamarans, cruisers), specialty watercraft (e.g., drift boats, airboats, inflatables, kayaks, houseboats), and/or the like, and of any size, without limit.

Furthermore, while many of those embodiments and examples discussed herein relate to the protection of electric over hydraulic brake actuators, it is further contemplated that the protective scheme may be extended to any combination of brake systems, safety systems, lighting systems, monitoring systems (e.g., tire pressure, load weight), camera systems (e.g., backup cameras), auxiliary power systems, winch systems, and/or the like which may be placed on a watercraft trailer but may nevertheless benefit from protection from the sort of submersion that occurs when launching and/or retrieving watercraft.

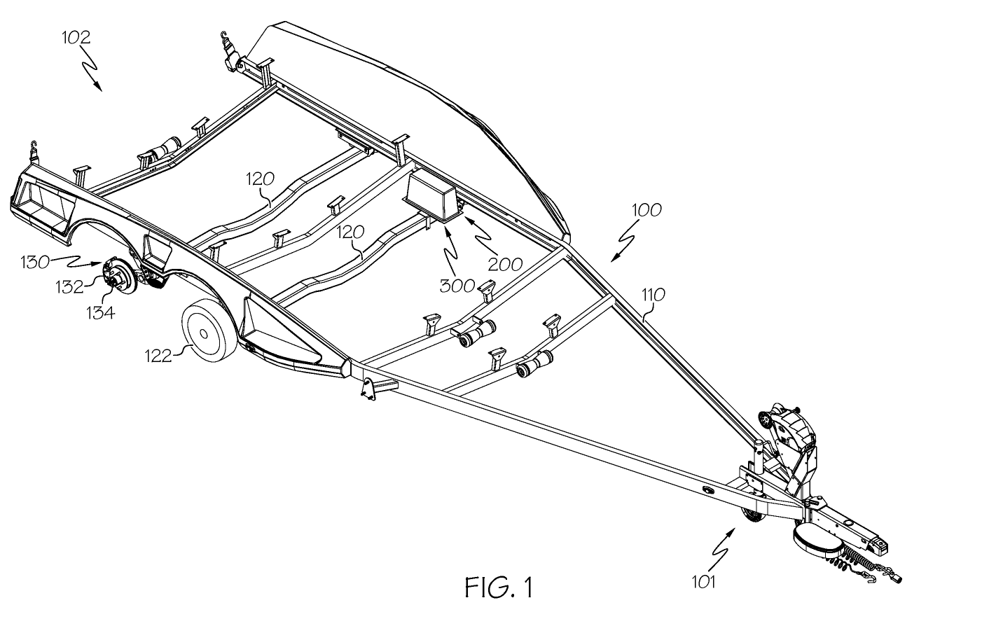

Turning now to FIG. 1, an illustrative watercraft trailer 100 is shown. The watercraft trailer 100 is capable of conveying a watercraft (not shown) and is capable of being at least partially submerged in water or some other fluid to launch and/or retrieve a watercraft further to those explanations above, such as from a boat ramp or a launch ramp. The watercraft trailer 100 has a front portion 101, where the watercraft trailer 100 may be hitched or otherwise coupled to a truck or other tow vehicle (not shown). The watercraft trailer 100 also has a rear portion 102, opposite the front portion 101.

The watercraft trailer 100 may include a frame 110 that serves as the general structure of the watercraft trailer 100 and one or more axles 120 to which one or more wheels 122 may be attached. In some embodiments, one or more of the axles 120 are torsion axles. Each axle 120 may be provided with at least one brake assembly 130 that may each include a piston assembly 132 (e.g., caliper, piston, brake pads, and/or the like) and a corresponding rotor 134 against which the piston assembly 132 acts to slow and/or stop rotation of the axle 120 and/or one or more wheels 122 attached thereto.

The watercraft trailer 100 may also include an electric over hydraulic brake system 300 that is hydraulically connected to the at least one brake assembly 130, such that actuation of the electric over hydraulic brake system 300 causes the piston assembly 132 to act against the disc 134 to brake the trailer 100. The electric over hydraulic brake system 300 may be provided beneath and/or within an enclosure 200 which is discussed in greater detail below.

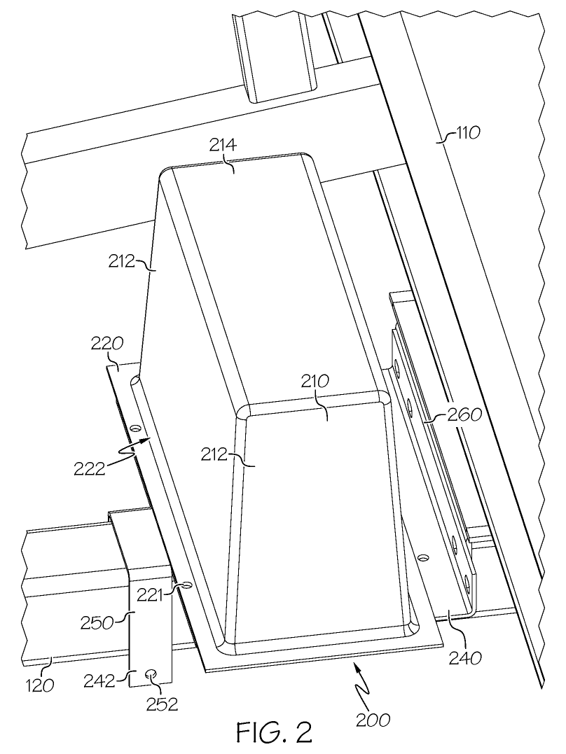

Turning now to FIG. 2, with continued reference to FIG. 1, embodiments relating to an enclosure 200 for protecting an electric over hydraulic brake system are shown in greater detail. The enclosure may include a cover 210 that is mounted to a platform 240. The platform 240 may, in turn, be mounted to a frame 110 and/or an axle 120 of the watercraft trailer 100. The cover 210 may have a substantially rectangular and/or trapezoidal shape, however it is contemplated that the cover 210 may have any shape (e.g., oblong, circular, elliptical, triangular, conical, cylindrical, and/or the like, without limit) sufficient to cover and/or enclose the electric over hydraulic brake actuator contained thereby.

In some embodiments, the cover 210 may have a top surface 214, a plurality of side surfaces 212 extending from the top surface 214, and a peripheral flange 220 provided at the bottom of the cover 210, extending from the plurality of side surfaces 212, opposite the top surface 214. In some embodiments, the peripheral flange 220 may be provided with at least one through-hole 221 for securing the cover 210 to the platform 240 via one or more fasteners (e.g., bolts, toggles, screws, thumb screws, tabs, and/or the like, without limit, not shown). In some embodiments, the peripheral flange 220 may be joined to the plurality of side surfaces 212 via a fillet 222, curved portion, and/or taper.

In some embodiments, the cover 210 may be shaped to have a nonzero draft angle (as shown) to assist with manufacturing methods such as injection molding, vacuum forming, casting, and/or other comparable molding methods. In other words, the cover 210 may be shaped to have a taper, slight or otherwise, applied to “vertical” walls of the cover 210, such that the side surfaces 212, absent any fillets or the like, meet the top surface 214 at an angle greater than 90 degrees. Provision of a nonzero draft angle in this manner permits the cover 210 to easily release from a mold or a buck. In some embodiments, the cover 210 may be shaped to have a draft angle of zero, or without any such taper. It may be appreciated that the provision of a draft angle or lack thereof does not significantly impact the function of the cover 210 and/or its ability to create an air pocket further to those disclosures herein.

In some embodiments, the cover 210 and/or the platform 240 may be formed from a durable material, such as metal, alloys, plastic, polymer, composites (e.g., fiberglass, carbon fiber, and/or the like), and/or some combination thereof. In some embodiments, the cover 210 and/or the platform 240 may be provided with one or more coatings to protect the cover 210 and/or the platform 240 from one or more environmental effects such as moisture (e.g., waterproof coatings, polyurea, and/or the like), ultraviolet radiation, dust, debris, and/or the like, without limit, and in any combination. The platform 240 may be formed of a different material from the cover 210. In some embodiments, the platform 240 may be formed of a metal (e.g., steel), and the cover 210 is formed/molded of plastic, composite, and/or the like.

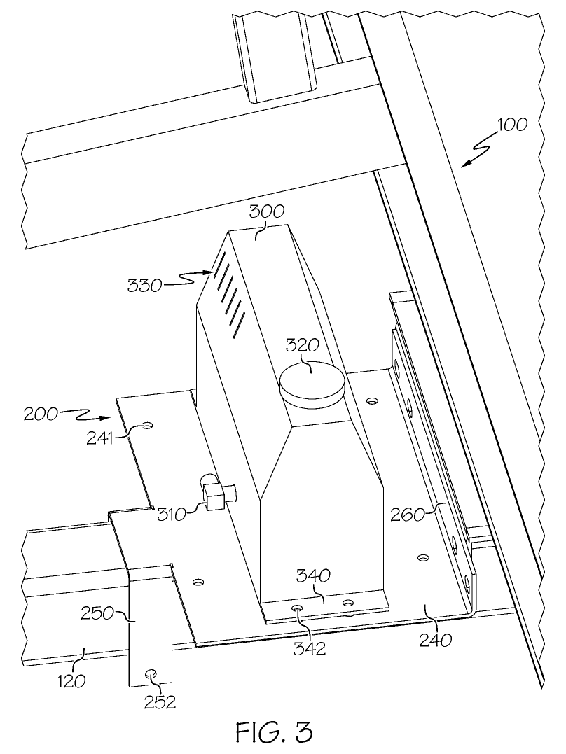

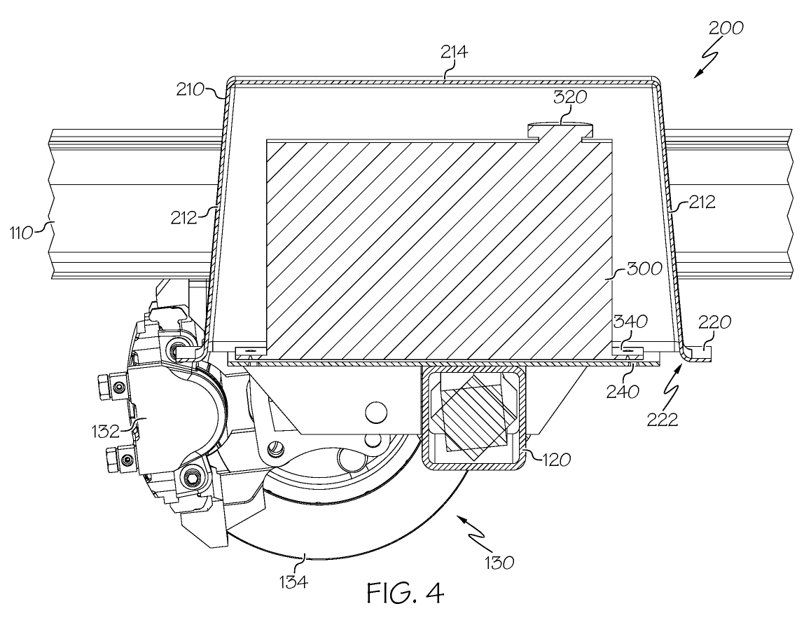

Turning now to FIGS. 3-4, with continued reference to FIGS. 1-2, the electric over hydraulic brake actuator 300 is shown with the cover 210 of the enclosure 200 removed. Here, it can be seen that the platform 240 is mounted to an axle 120 of the frame 110 of the watercraft trailer 100 in a generally horizontal position. In some embodiments, the platform is provided with one or more through-holes 241 that correspond to through-holes 221 of the cover 210, so that the cover 210 may be secured to the platform 240.

In some embodiments, the platform 240 is provided with a clamp 250 that extends below the platform 240 to fit at least partially around the axle 120. The clamp 250 may be provided with one or more through-holes 252. In some embodiments, the through-holes 252 permit the clamp 250 to be fastened (e.g., via one or more bolts, toggles, screws, thumb screws, tabs, and/or the like, without limit, not shown) directly to the axle 120. In some embodiments, the through-holes 252 permit a fastener or other support element to extend beneath the axle 120 so that the clamp 250 may extend completely around the axle 120 to secure the platform 240 to the axle 120. In some embodiments, the platform 240 is provided with a connecting flange 260 having one or more through-holes that permit the platform to be fastened directly to the frame 110 of the watercraft trailer 100 via one or more fasteners (e.g., bolts, toggles, screws, thumb screws, tabs, and/or the like, without limit, not shown). In some embodiments, the platform 240 is provided with both the clamp 250 and the connecting flange 260. In some embodiments, the platform 240 is provided with multiple clamps 250, such as on opposite sides of the actuator 300.

In some embodiments, one or more clamps 250 clamp to a crossbeam or other support member of the frame 110 of the watercraft trailer 100. In some embodiments, the platform 240 is mounted closer to the rear portion 102 of the watercraft trailer 100 than the front portion 101 of the watercraft trailer 100. In this way, the electric over hydraulic actuator 300 and/or enclosure 200 may be disposed in a significantly less visible location, such as down near and/or on the axles 120 of the watercraft trailer 100 or hidden by wheel wells or trim pieces instead of up at the front portion 101 near the hitch.

Also shown in FIGS. 3-4 is an electric over hydraulic brake actuator 300 secured to the top of the platform 240. The actuator 300 may be provided with an actuator flange 340 having one or more actuator flange through-holes 342 via which the actuator may be secured to the platform 240 by one or more fasteners (e.g., bolts, toggles, screws, thumb screws, tabs, and/or the like, without limit, not shown). The actuator may have one or more brake line ports 310, or hydraulic ports, to which one or more brake lines (not shown) may be attached to hydraulically connect the actuator 300 to the one or more piston assemblies 132. Specifically, the brake line can be coupled to the brake line port 310 so that brake fluid can flow from a reservoir within the actuator 300 and into the brake line to the one or more piston assemblies 132. In some embodiments, the actuator 300 may be provided with a removable cap 320 for adding brake fluid to the reservoir.

In some embodiments, actuator wiring (not shown) may be routed (e.g., independently and/or as part of a wiring harness) towards the front portion 101 of the watercraft trailer 100 for further connections to the control systems of the towing vehicle. As a result of these electrical connections, when the towing vehicle’s brakes are applied, the vehicle’s controller provides a signal via the actuator wiring to the actuator 300 to control the actuator 300 to activate (e.g., by driving the motors, pumps, pistons, and/or the like to increase pressure within the brake lines) and, in turn, activate the brake assemblies 130. The amount of braking force applied by the brake assemblies may be proportional to the amount of braking force requested from the towing vehicle and/or an operator of the towing vehicle. Though not shown in the Figures, the actuator wiring may also be connected to a breakaway kit for emergency braking in the event the watercraft trailer 100 is separated from the towing vehicle while in motion.

In some embodiments, the electric over hydraulic brake actuator 300 may be commercially available, from suppliers such as DEEMAXX COMPONENTS of Aledo, Texas. The actuator 300 may further include one or more motors, pumps, and/or the like (not shown) for generating pressure within the brake lines and pumping brake fluid from a reservoir within the actuator 300 through the brake lines to the one or more piston assemblies 132. In some embodiments, the actuator 300 may have one or more vent holes 330 provided in a housing of the actuator to provide ventilation to those components therein for cooling purposes and/or the like.

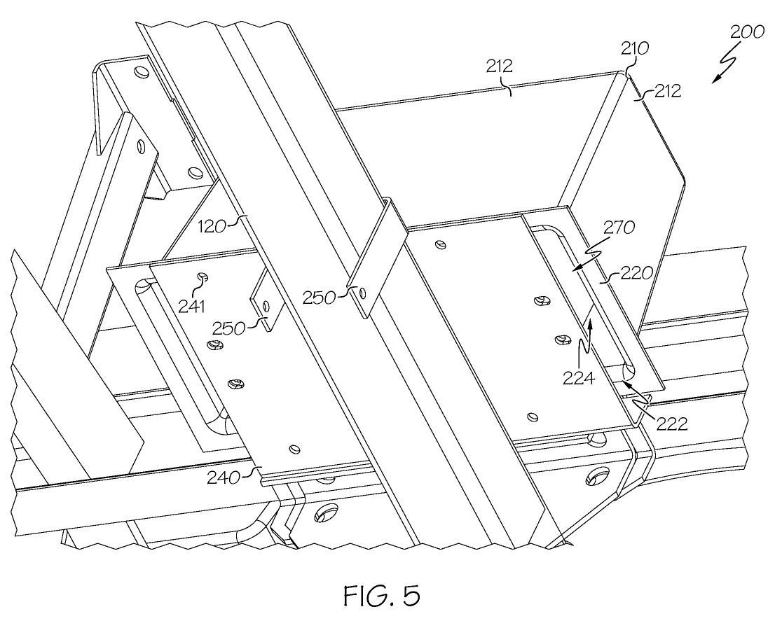

Turning briefly now to FIG. 5, with continued reference to FIGS. 2-4, embodiments of the enclosure 200 are shown viewed from below. Here, it can be seen that a gap 270 may formed present between an edge of the platform 240 and the peripheral flange 220 of the cover 210, such that an actuator-receiving opening 224 of the cover 210 is partially exposed along at least one edge of the platform 240. That is to say, in some embodiments, the enclosure 240 is not necessarily water tight. In such embodiments, the brake lines and/or actuator wiring may be routed to pass through the gap 270 and into the internal cavity of the enclosure 200 for connection with the electric over hydraulic brake actuator 300. Provision of the gap 270 in this manner facilitates more flexible routing of the brake lines and/or actuator wiring, allows any water and/or moisture accumulation (e.g., condensation) to drain or otherwise be expelled from the enclosure. In some embodiments, the gap 270 is approximately ½ inch (1.3 cm) or less between the platform 240 and the peripheral flange 220, though other sizes are contemplated and possible. In some embodiments, more than one gap 270 may be present between the cover 210 and the platform 240, such as at either end of the cover 210.

However, it is also contemplated that some embodiments may omit the gap 270, such that the peripheral flange 220 seals about its perimeter against the platform 240 to establish an air- and/or water-tight seal against the platform 240. In such embodiments, one or more through-holes, grommets, glands, fittings, and/or the like may be provided to allow the brake lines and/or actuator wiring to pass into the internal cavity of the enclosure 200 while maintaining the air- and/or water-tight seal.

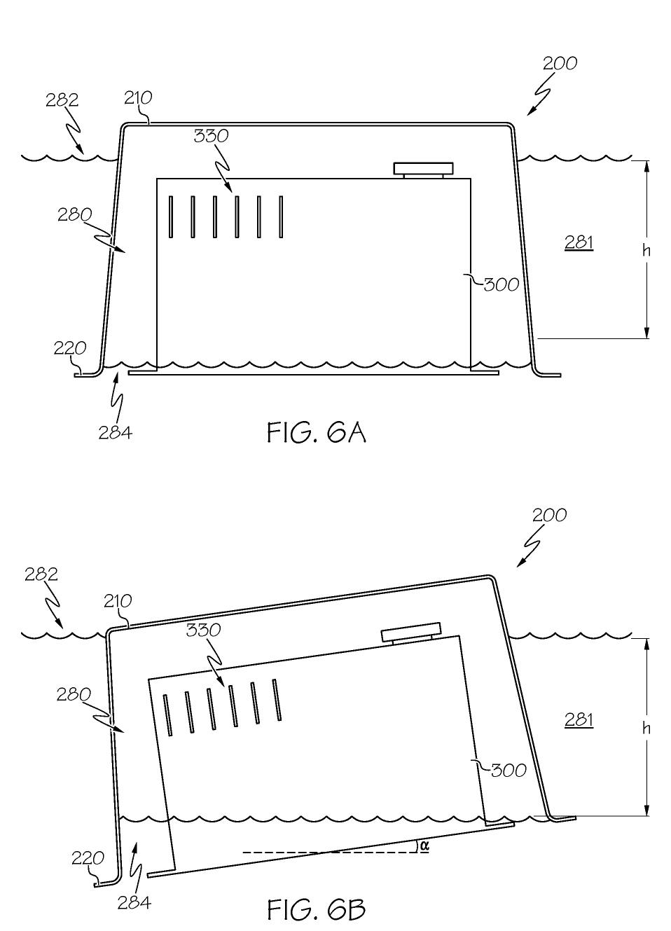

Turning now to FIGS. 6A-6B, with continued reference to FIGS. 2-5, two exemplary scenarios are presented to illustrate various embodiments of the enclosure 200 and related operative means when the enclosure 200 is submerged. In FIG. 6A, the enclosure 200 is shown submerged with no tilt angle or with a tilt angle of zero, that is, the platform 240 is substantially parallel to a horizontal axis. In FIG. 6B, the enclosure 200 is shown with a tilt angle α. Here, the tilt angle α may reflect any combination of a tilt of the watercraft trailer 100 and/or an angle of the boat ramp. Common angles for boat ramps may fall within a range of 5 to 15 degrees or 6 to 12 degrees. In both scenarios, the enclosure 200 is shown submerged in a body of water 281 having an environmental water level 282 such that, absent the enclosure 200, the electric over hydraulic brake actuator 300 would otherwise be substantially submerged in the water.

However, by providing the enclosure 200, submerging the actuator 300 and enclosure 200 in the water does not result in flooding of the actuator 300. Instead, submerging the enclosure 200 causes air to become trapped within an interior cavity 280 of the cover 210 of the enclosure 200, thereby preventing further ingress of water into the interior cavity 280 of the cover 210. As a result, the enclosure water level 284 differs from the environmental water level 282 by a height h. While this may nevertheless result in some water coming into contact with the actuator 300, in some embodiments, such contact is inconsequential. In some embodiments, that water that contacts the actuator 300 does not engulf the actuator 300 to an extent that risks ingress through vent slits 330 and/or other similar non-water-tight features of a housing of the actuator 300.

Still, it is contemplated that, in some embodiments, the cover 210 may be shaped to extend beneath the platform 240, such that the enclosure water level 284 stays below the actuator 300 and does not contact the actuator 300 when the watercraft trailer 100 is submerged regardless of the tilt angle and/or for tilt angles within a range of 5 to 15 degrees or 6 to 12 degrees.

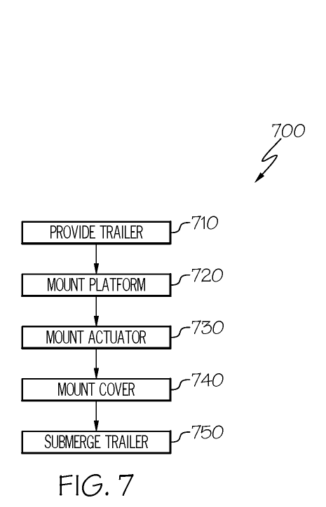

Turning now to FIG. 7, with continued reference to FIGS. 1-6, embodiments relating to a method 700 for equipping a watercraft trailer with an electric over hydraulic brake system are shown.

In step 710, the watercraft trailer 100 is provided. In step 720, the platform 240 is mounted to the watercraft trailer 100. As discussed above, the platform 240 may be mounted to and/or otherwise secured to (e.g., via fasteners, welding, and/or the like) an axle 120 of the vehicle trailer 100 or other portion of the frame 110. In some embodiments, the platform 240 may be mounted closer to a rear portion 102 of the watercraft trailer 100 than a front portion 101 of the watercraft trailer 100. In step 730, an electric over hydraulic brake actuator 300 may be mounted to the platform 240. In step 740, a cover 210 may be mounted to the platform 240 so as to cover the electric over hydraulic brake actuator 300 and/or to dispose the electric over hydraulic brake actuator 300 within an internal cavity 280 at least partially enclosed by the cover 210. In this way, submerging the electric over hydraulic brake system in water or some other fluid results in an air pocket becoming trapped within the internal cavity 280, providing protection to the electric over hydraulic brake actuator 300. In some embodiments, even while protected by the air pocket, the electric over hydraulic brake actuator 300 may be at least partially submerged in the fluid but only to an inconsequential extent. That is to say, the electric over hydraulic brake actuator 300 does not suffer any loss or inhibition of function and/or the electric over hydraulic brake actuator 300 does not suffer any damage as a result of this at least partial submersion. Additionally and/or alternatively, it may be said that fluid may contact the bottom portions of the electric over hydraulic brake actuator 300, but not those top portions where the cap 320, vent slits 330, wiring and/or wiring glands, and/or the like may be located.

Finally, in an optional step 750, and/or in the course of using and/or operating the watercraft trailer 100 and/or the electric over hydraulic brake system, the watercraft trailer 100 with the electric over hydraulic brake actuator 300 and enclosure 200 mounted thereto, may be at least partially submerged in a body of water, such as by backing or otherwise conveying the watercraft trailer 100 into the body of water (e.g., via a boat ramp or the like) with a towing vehicle. In doing so, the electric over hydraulic brake actuator 300 with the enclosure 200, may become at least partially submerged within the body of water.

It should now be understood that embodiments of the present disclosure are directed to an enclosure for protecting an electric over hydraulic brake actuator of a watercraft trailer for when the trailer is submerged, such as when launching or retrieving a watercraft.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise structure, steps, and/or forms disclosed, and obviously many modifications and variations are possible in light of the above teaching.

1. An electric over hydraulic brake system comprising:
a platform configured to mount to a watercraft trailer;
an electric over hydraulic brake actuator that is mountable to the platform and configured to actuate one or more brakes of the watercraft trailer; and
a cover configured to mount to the platform, wherein:
the cover defines an interior cavity inside of which the electric over hydraulic brake actuator is disposed when the cover is mounted to the platform over the electric over hydraulic brake actuator.

2. The electric over hydraulic brake system of claim 1, wherein the cover is configured to trap a pocket of air within the interior cavity when the cover is at least partially submerged in a fluid.

3. The electric over hydraulic brake system of claim 2, wherein, when at least partially submerged in the fluid, the pocket of air prevents the fluid from contacting at least a portion of the electric over hydraulic brake actuator.

4. The electric over hydraulic brake system of claim 3, wherein, when at least partially submerged in the fluid, the fluid contacts at least a portion of the electric over hydraulic brake actuator.

5. The electric over hydraulic brake system of claim 2, wherein the cover comprises a peripheral flange having at least one through-hole for mounting to the platform.

6. The electric over hydraulic brake system of claim 5, wherein the peripheral flange extends around a perimeter of the cover.

7. The electric over hydraulic brake system of claim 1, wherein the platform comprises at least one clamp for securing the platform to the watercraft trailer.

8. The electric over hydraulic brake system of claim 7, wherein the at least one clamp is configured to attach to an axle of the watercraft trailer.

9. The electric over hydraulic brake system of claim 1, wherein a gap is present between an edge of the cover and the platform.

10. The electric over hydraulic brake system of claim 9, wherein the gap is approximately ½ inch wide.

11. The electric over hydraulic brake system of claim 9, wherein the gap is sized to pass at least one of a brake line and an actuator wiring of the electric over hydraulic brake actuator.

12. A watercraft trailer comprising the electric over hydraulic brake system of claim 1.

13. The watercraft trailer of claim 12, further comprising an axle, wherein the electric over hydraulic brake system is mounted to the axle.

14. The watercraft trailer of claim 12, wherein the electric over hydraulic brake system is mounted closer to a rear of the watercraft trailer than a front of the watercraft trailer.

15. The watercraft trailer of claim 12, wherein the cover is configured to trap a pocket of air within the interior cavity when the cover is submerged in a fluid.

16. A method for using the electric over hydraulic brake system of claim 1, comprising:
mounting the electric over hydraulic brake system to the watercraft trailer; and
conveying the watercraft trailer at least partially into a body of water so as to at least partially submerge the electric over hydraulic brake system in the body of water.

17. A method for equipping a watercraft trailer with an electric over hydraulic brake system, comprising the steps of:
providing the watercraft trailer;
mounting a platform to the watercraft trailer;
mounting an electric over hydraulic brake actuator to the platform; and
mounting a cover to the platform, wherein:
the cover at least defines an interior cavity inside of which the electric over hydraulic brake actuator is disposed.

18. The method of claim 17, wherein mounting the platform to the watercraft trailer comprises mounting the platform to an axle of the watercraft trailer.

19. The method of claim 17, wherein mounting the platform to the watercraft trailer comprises mounting the platform is closer to a rear of the watercraft trailer than a front of the watercraft trailer.

20. The method of claim 17, wherein mounting the cover to the platform comprises positioning the cover relative to the flatform to form a gap between the cover and the platform, the gap being sized to pass at least one of a brake line and an actuator wiring of the electric over hydraulic brake actuator.
